(19) United States
(12) Patent Application Publication
(10) Pub. No.: US 2006/0014624 A1
(43) Pub. Date: Jan. 19, 2006

(54) High dielectric strength monolithic Si3N4

(76) Inventor: Biljana Mikijelj, Cerritos, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/892,721

(22) Filed: Jul. 15, 2004

(51) Int. Cl. C04B 35/587

(52) U.S. Cl. 501/97.2; 501/97.4

(57) ABSTRACT

A monolithic silicon nitride material and a method of manufacturing the material. The material is disclosed in a range of composition variations all of which exhibit high dielectric strengths suitable for use in insulator applications. Moreover, the material retains its dielectric and structural integrity even at elevated temperature, such as above 800 degrees Celsius. One embodiment of the method of manufacture is an SRBSN process comprising powder batching, powder pressing, binder removal, nitriding and sintering. The second embodiment is an SSN process comprising powder batching, binder removal and sintering. In either embodiment, the resulting Si₃N₄ composition also comprises up to 20% by weight of Al₂O₃, up to 15% by weight rare earth oxides and up to 5% by weight of other constituents.

### BACKGROUND OF THE INVENTION

1. Field of the Invention

The present invention pertains generally to the field of technical ceramic materials and more specifically to a high dielectric monolithic Silicon Nitride material for high voltage insulating applications.

2. Prior Art

Alumina (Al₂O₃) containing ceramics (>94%), aluminum nitride—AlN and beryllium oxide—BeO are insulating materials that are most commonly used in electrically insulating applications where high dielectric strength materials are required. Of the three materials, Al₂O₃ and AlN are considered to have higher dielectric strengths than BeO.

Dielectric strength is the maximum electrical voltage a material can withstand across its thickness before it fails as an electric insulator.

In many insulator applications where the insulating material is substantially exposed to thermal cycling, alumina (most commonly used ceramic) may exhibit thermal shock problems. Beryllia is now rarely being used due to the toxicity associated with it. Si₃N₄ is a material which is a good candidate for this application due to its excellent thermal shock properties and high strength and fracture toughness, if high dielectric strength material were developed for this application.

A search of the prior art has revealed the following U.S. patents which are relevant to varying degrees:
U.S. Pat. No. 3,793,090 Barile et al
U.S. Pat. No. 4,344,390 Heydrich et al
U.S. Pat. No. 4,420,497 Tickle
U.S. Pat. No. 4,482,388 Crosbie
U.S. Pat. No. 4,950,558 Sarin
U.S. Pat. No. 5,040,504 Matsuoka
U.S. Pat. No. 5,157,972 Broden et al
U.S. Pat. No. 5,205,170 Blechinger et al
U.S. Pat. No. 5,236,684 Krause
U.S. Pat. No. 5,332,697 Smith et al
U.S. Pat. No. 5,358,645 Hong et al
U.S. Pat. No. 5,245,846 Koze et al
U.S. Pat. No. 5,435,608 Wei et al
U.S. Pat. No. 5,455,212 Das Chaklader et al
U.S. Pat. No. 5,488,019 Abe et al
U.S. Pat. No. 5,518,949 Chen
U.S. Pat. No. 5,522,371 Kawamura
U.S. Pat. No. 5,679,980 Summerfelt
U.S. Pat. No. 5,696,018 Summerfelt et al

Of the foregoing patents, the following appear to be most pertinent:

U.S. Pat. No. 5,157,972 to Broden et al is directed to a pressure sensor for sensing fluid pressure wherein a diaphragm layer is bonded to a portion of a high modulus support block. Referring to FIG. 5, a sensor body 70 includes a diaphragm layer 50 which is bonded to support blocks 40. Each support block 40 is formed of a high modulus ceramic material, the preferred material being, specifically, “endowed SRBSN” or “SSN” ceramic material. Although the sensor support block 40 is formed of a high modulus ceramic material which is also electrically insulating, high dielectric strength of the material is not essential in this application due to the low voltages applied to the ceramic block in the sensor. No reference is made to dielectric strength of the block material.

U.S. Pat. No. 4,950,558 to Sarin is directed to a protectively-coated ceramic article adapted for use in ceramic heat engine applications. While it is clear that the material compositions of the article's substrate and coatings are selected primarily for their thermal and mechanical properties, the substrate is nevertheless specified to be formed of, among other things, a monolithic silicon nitride ceramic material such as reaction bonded silicon nitride (RBSN) or sintered silicon nitride (SSN). This patent covers oxidation resistant protective coatings on silicon based materials which improve the high temperature chemical and mechanical properties of the underlying material. Although the underlying material can be silicon nitride, this has no bearing on the invention at hand which deals with high dielectric strength silicon nitride materials. This property is not mentioned anywhere in the patent.

U.S. Pat. No. 5,435,608 to Wei et al is directed to a solid state radiation imager having a pixel array, each pixel of which includes a photosensor and a thin film transistor (TFT). The photosensor and the TFT are formed with a common dielectric layer that is specified to be a monolithic silicon nitride material. The described common dielectric layer specified to be a “monolithic” material such as silicon nitride is described to be formed by plasma enhanced chemical vapor deposition and is only 0.05-0.5 μm thick. This is a thick film in actuality and not a monolithic material. No specific requirements on dielectric strength of the dielectric are specified in the invention.

U.S. Pat. No. 5,455,212 to Das Chaklader et al is directed to a method for producing alumina-silicon carbide ceramic powders. The Background of the Invention, however, notably mentions that many composites formed from monolithic ceramic materials such as silicon nitride have found application in heat engine components. It also mentions that extensive research is underway to produce ceramic composites “using matrix such as . . . silicon nitride . . . reinforced by [other] materials,”. This patent is directed towards alumina-silicon carbide powder production. Silicon nitride is not the object of the invention nor is dielectric strength mentioned anywhere.

U.S. Pat. No. 4,344,390 to Heydrich et al is directed to a piston-cylinder assembly for an internal combustion engine. A number of components in the assembly shown in FIG. 3 are specified to be formed of monolithic silicon nitride. While it appears to be primarily the thermal and mechanical properties underlying the selection of silicon nitride as their material composition, end piece 120 and spacer 117 are nonetheless specified to be monolithic pieces of sintered silicon nitride. The monolithic silicon nitride piston-assembly is here specified due to mechanical and thermal properties. High dielectric strength is not mentioned, specified or required.

U.S. Pat. No. 5,358,645 to Hong et al is directed to a process for high temperature water oxidation of combustible materials. Table 1 lists the various zirconium oxide types that were tested in the disclosed process. While no mention is made of silicon nitride, it is notable that the materials listed include in varying weight percentages MgO, CaO, Y₂O₃, Al₂O₃, SiO₂, TiO₂, and Fe₂O₃. This patent discloses a process and apparatus for high temperature water oxidation of combustibles using a zirconia based ceramic. This is entirely unrelated to silicon nitride, and although the additives may be similar, their addition is made for an entirely different purpose.

U.S. Pat. No. 5,696,018 to Summerfelt et al is directed to a method of forming multi-layered high-dielectric constant materials. The Specification notes that among the dielectric materials selected for use as the insulator material for being “exceptional in their barrier properties” is Si₃N₄. It also states that “[i]t is . . . impossible to combine various dielectrics and noble metals in order to tailor the barrier layer to a particular application,”. This patent describes a forming method for multi-layered high-dielectric constant materials—a different material property than claimed dielectric strength. The same patent states that among dielectric materials selected for use as insulator material for being “exceptional in their barrier properties” is Si₃N₄, however the barrier properties referred to are chemical diffusion barrier properties.

U.S. Pat. No. 5,425,846 (Koze et al) describes a method of removal of substrate perimeter material during the production of semiconductor devices. Here, dielectric cap (typically silicon dioxide or silicon nitride) is described as a 50 nm thick layer in case of silicon nitride. This would be considered a thin film, not a monolithic ceramic. In addition, the main function of the cap is to prevent dopants in the wafer from out-diffusing from the back side of the wafer. High dielectric strength is not an issue in the patent.

### SUMMARY OF THE INVENTION

The invention comprises a monolithic silicon nitride material and a method of manufacturing the material. The material is disclosed in a range of composition variations all of which exhibit high dielectric strengths suitable for use in insulator applications. Moreover, the material retains its dielectric and structural integrity even at elevated temperature, such as above 800 degrees Celsius.

The method of manufacture is disclosed in two distinct embodiments. One embodiment of the method of manufacture is an SRBSN process comprising powder batching, powder pressing, binder removal, nitriding and sintering. The second embodiment is an SSN process comprising powder batching, binder removal and sintering. In either embodiment, the resulting Si₃N₄ composition also comprises up to 20% by weight of Al₂O₃, up to 15% by weight rare earth oxides and up to 5% by weight of other constituents to be described hereinafter.

### OBJECTS OF THE INVENTION

It is therefore a principal object of the present invention to provide a monolithic silicon nitride composition that exhibits high dielectric strength (over 2000 V/mil by ASTM D149 method on 10 mil thick sample) and that is relatively immune to thermal cycling between room temperature and at least 800 degrees Celsius.

It is another object of the invention to provide an electric insulator material that is of high strength, resistant to fracture and capable of withstanding thermal shock without degradation of structural properties.

It is still another object of the invention to provide a process for the manufacture of high dielectric monolithic silicon nitride compositions which are thermally and structurally superior to known insulator materials.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a graphical representation of average dielectric strength of various prior art and inventive compositions; and

FIG. 2 is a graphical representation of electrical resistance versus temperature for the prior art and inventive compositions of FIG. 1.

### DETAILED DESCRIPTION OF PREFERRED EMBODIMENTS

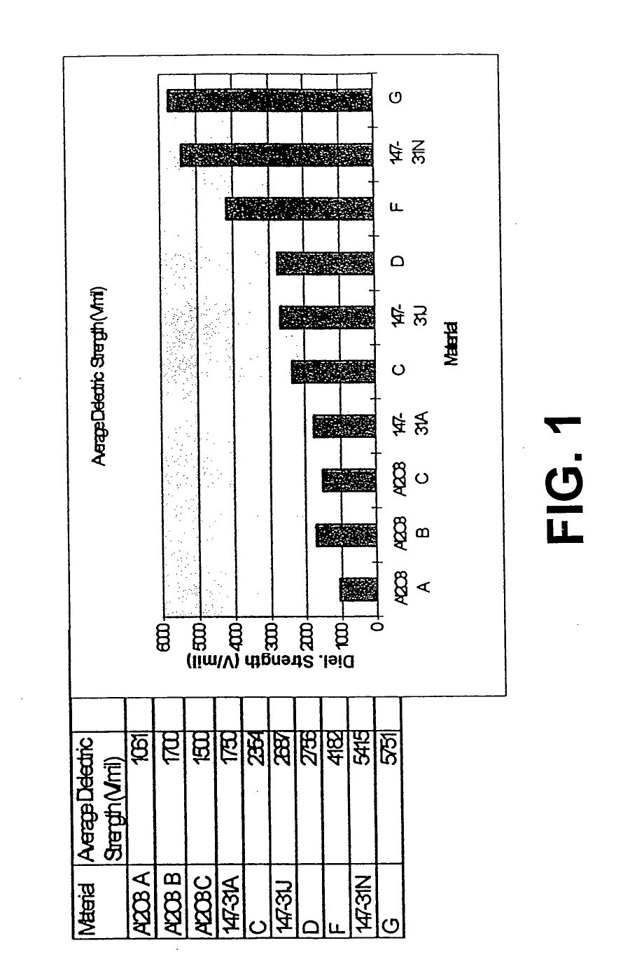

A range of Si₃N₄ compositions have been developed which exhibit dielectric strengths in the same range or substantially higher than commercial alumina and aluminum nitride materials. FIG. 1 shows the average dielectric strengths of three commercially available alumina materials and several Si₃N₄ compositions, the constituents of which are listed in Table 1.

TABLE 1
Si₃N₄ compositions

| Additive/ | | | | | | | | | |
|---|---|---|---|---|---|---|---|---|---|
| Composition | | | | | | | | | color |
| (%) | La₂O₃ | Al₂O₃ | Y₂O₃ | CeO₂ | Er₂O₃ | SiO₂ | MgO | Fe₂O₃ | agent |
| 147-31N | — | 5 | 2 | — | — | — | — | — | 0.07 |
| A | — | 10 | 2 | — | — | — | — | — | 0.07 |
| B | — | 16 | 2 | — | — | — | — | — | 0.07 |
| C | — | 2 | — | 10 | — | — | — | — | 0.07 |
| D | — | — | — | — | 8 | 2.5 | 0.5 | — | 0.07 |
| 147-31J | — | 5 | 2 | — | — | — | — | — | 0.07 |
| F | 5 | 2 | — | — | — | — | — | — | 0.07 |
| G | — | 5 | 2 | — | — | — | 0.25 | — | 0.07 |
| 147-31A | — | 2 | 8 | — | — | — | — | — | — |

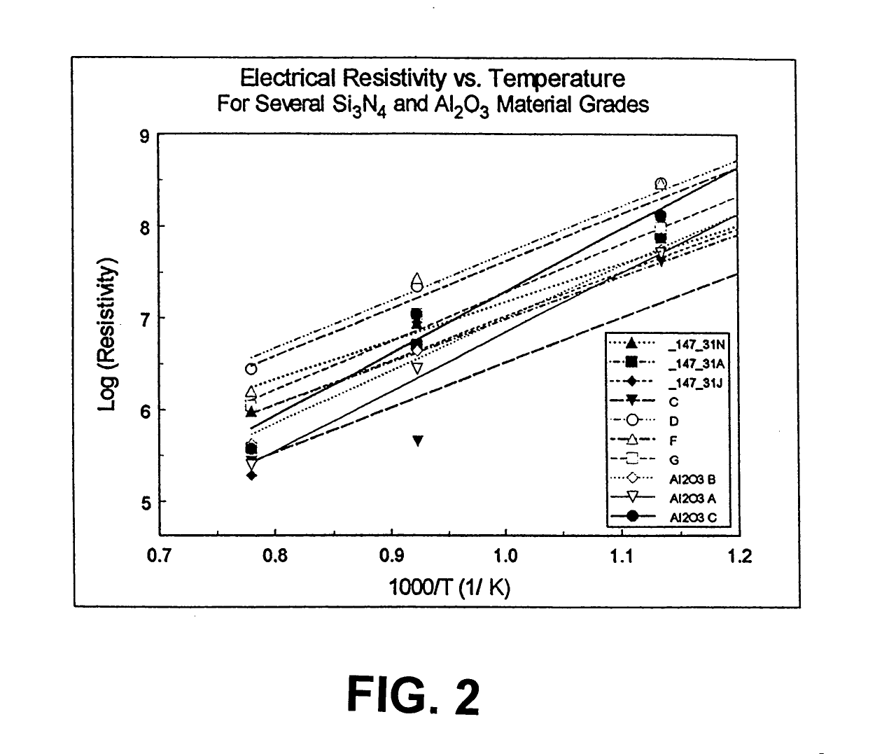

FIG. 1 shows that the newly developed silicon nitride materials have equivalent or substantially higher dielectric strengths than alumina materials. In addition, most of the invented silicon nitride materials also have higher electrical volume resistivity than alumina insulating materials at temperatures above 800 degrees Celsius, allowing them to be used at elevated temperatures (FIG. 2). These properties permit the silicon nitride materials to be used as high voltage insulating material in high voltage jet engine igniters and in other electrical applications where high voltage insulation is required at either room temperature or elevated temperatures.

Pure silicon nitride CVD or PVD thin films (less than 25 μm) exhibit high dielectric strengths, however no data has been found in the general or patent literature on high dielectric strength monolithic Si₃N₄.

Monolithic silicon nitride materials can be made using the following methods:

SRBSN Process

Powder Batching: Si fine powder is mixed in a slurry or dry form with appropriate sintering aids (Al₂O₃, MgO, CaO, Li₂O, SiO₂, Y₂O₃, La₂O₃, CeO₂, Er₂O₃ and other rare earth oxides or their equivalent which will yield the same after heating at processing temperatures). Small amounts of Mo₂C, TiO₂, TiN or Fe₂O₃ can also be added to the powder. Binder may be added to the powder to aid in subsequent pressing of the powder. The powder slurry is dried such as by spray drying to form a powder that can be pressed.

Powder pressing: the batched powder is pressed using a dry press or an isopress. Alternatively, powder can be consolidated using injection molding, gel-casting, tape casting or other ceramic powder consolidation techniques starting from the slurry form and used by those skilled in the art.

Binder Removal: Consolidated parts are dried and the binder removed at temperatures from 300-700 degrees Celsius in air or inert atmosphere depending on the binder system, or the binder can be removed by chemically leaching it out.

Nitriding: Parts are nitrided in a refractory metal or other furnace by heating the parts in a nitrogen or NH₃ containing furnace at temperatures ranging from 1000-1450 degrees Celsius until all of the Si powder is reacted and forms Si₃N₄.

Sintering: After nitriding, the parts are sintered in a graphite element or other furnace to temperatures ranging from 1500-2000 degrees Celsius, preferably 1700-1950 degrees Celsius in a nitrogen atmosphere. The sintering can be performed at ambient nitrogen pressure, or gas-pressure sintering or hip-ing techniques can be used. Alternatively, powder can be consolidated by hot pressing.

SSN Process

Powder Batching: Si₃N₄ fine powder is mixed in a slurry or dry form with appropriate sintering aids (Al₂O₃, MgO, CaO, Li₂O, SiO₂, Y₂O₃, La₂O₃, CeO₂, Er₂O₃ and other rare earth oxides or their equivalents, which will yield the same final oxide ratio after heating at processing temperatures). Small amounts of Mo₂C, TiO₂, TiN or Fe₂O₃ may also be added to the powder. Binder may be added to the powder to aid in subsequent pressing of the powder. The powder slurry is dried such as by spray drying to form a powder than can be pressed.

Powder pressing: the batched powder is pressed using a dry press or an isopress. Alternatively, powder can be consolidated using injection molding, gel-casting, tape casting or other ceramic powder consolidation techniques starting from the slurry form and used by those skilled in the art.

Binder Removal: Consolidated parts are dried and the binder removed at temperatures from 300-700 degrees Celsius in air or inert atmosphere depending on the binder system, or the binder can be removed by chemically leaching it out.

Sintering: After nitriding, the parts are sintered in a graphite element or other furnace to temperatures ranging from 1500-2000 degrees Celsius, or preferably 1700-1950 degrees Celsius in a nitrogen atmosphere. The sintering can be performed at ambient nitrogen pressure, or gas-pressure sintering or hip-ing techniques can be used. Alternatively, powder can be consolidated by hot pressing.

The result of either embodiment of manufacture is a monolithic Silicon Nitride having the following additional constituents:
Al₂O₃: 1-20 wt %
Rare earth oxides, single or mixture (Y₂O₃, La₂O₃, CeO₂, Er₂O₃, etc.): 0.5-15 wt %
MgO, CaO, Li₂O, SiO₂: 0-3 wt % total
Mo₂C, Fe₂O₃, Tio₂, TiN: 0-2% total

Having thus described preferred embodiments of the invention, it being understood that such embodiments are exemplary illustrations and not necessarily limiting of the scope hereof,

What is claimed is:

1. A monolithic dielectric material with dielectric strengths over 2000 V/mil comprising:
Si₃N₄ sintered and having homogeneously dispersed therein Al₂O₃ in an amount of 1% to 20% by weight and at least one oxide taken from the group consisting of Y₂O₃, La₂O₃, CeO₂, Er₂O₃ or other rare oxide and mixtures thereof in an amount of 0.5 to 15% by weight.

2. A monolithic dielectric material with dielectric strengths over 2000 V/mil comprising:
Si₃N₄ sintered and having homogeniously dispersed therein Al₂O₃ in an amount of up to 20% by weight, at least one rare earth oxide of up to 15% by weight, at least one of the group consisting of MgO, CaO, Li₂O and SiO₂ and mixtures thereof in an amount of up to 3% by weight and up to 2% by weight of at least one of the group consisting of Mo₂C, Fe₂O₃, TiO₂ and TiN.

3. A method of manufacturing a monolithic dielectric material with dielectric strengths over 2000 V/mil formed primarily of silicon nitride; the method comprising the following steps:
a) mixing fine powder silicon with a sintering aid and a binder;
b) pressing the mixture into a desired shape;
c) removing the binder from said pressed shape;
d) nitriding the pressed shape until substantially all of the silicon is reacted to form Si₃N₄;
e) sintering the nitrided, pressed shape.

4. The method recited in claim 3 wherein in step a) said sintering aid is taken from the group consisting of Al₂O₃, MgO, CaO, Li₂O, SiO₂, Y₂O₃, La₂O₃, CeO₂ and Er₂O₃ and other rare earth oxides.

5. The method recited in claim 3 wherein step a) also comprises forming a slurry of said mixture and then drying said slurry.

6. The method recited in claim 3 wherein step c) is performed by subjecting said pressed shape to a temperature of 300 to 700 degrees Celsius.

7. The method recited in claim 3 wherein step d) is performed by heating the pressed shape to a temperature of 1000 to 1450 degrees Celsius in a nitrogen atmosphere.

8. The method recited in claim 3 wherein step e) is performed by heating the nitrided, pressed shape to a temperature of 1600 to 2000 degrees Celsius in a nitrogen atmosphere.

9. The method recited in claim 3 wherein in step a) Si₃N₄ powder is included in said mixing.

10. The method recited in claim 3 wherein in step a) said mixing powder also comprises at least one of the group consisting of Mo₂C, TiO₂, TiN and Fe₂O₃.
